(19) United States
(12) Patent Application Publication
(10) Pub. No.: US 2022/0098451 A1
(43) Pub. Date: Mar. 31, 2022

(54) STRETCH RELEASE ADHESIVE ARTICLE WITH HEXAGONAL MESH

(71) Applicant: Samir Hanna Safar, San Diego, CA (US)

(72) Inventor: Samir Hanna Safar, San Diego, CA (US)

(21) Appl. No.: 17/035,888

(22) Filed: Sep. 29, 2020

(51) Int. Cl. C09J 7/40; C09J 7/38

(52) U.S. Cl. CPC C09J 7/403; C09J 7/38; C09J 2301/204; C09J 2301/302; C09J 2301/208; C09J 2301/308

(57) ABSTRACT

An adhesive article adapted for removable adhesive bonding between any shaped surfaces of the objects, includes stretch release mesh layers. The non-adhesive mesh layers are sequential release type strips with affixed lobes attached on sides and front back portion of the mesh strips which are stretched for progressive release of the surfaces of the adhesive strip from the surfaces of the objects and provide separation between each other. Another central mesh, provides a sequential release from the major surfaces between adhesive strips. This sequential release reduces the incidence of unwanted damage to surface and also able to hold heavy weight with that adhesive article. To prevent unwanted damage during movement between the surface of objects and adhesive strips and between the major surfaces of adhesive strips in the removal process and therefore provides successful sequential release of the surfaces of the objects.

### FIELD OF THE INVENTION

The present invention relates generally to stretch releasing adhesive articles attached with any shaped surface such as even rough surface that can be cleanly removed from a substrate and, such as a wall surface, and can hold heavy weight without damaging the surfaces. The invention provides the ease of separation between the major surfaces of adhesive strips and from the surfaces of the objects without any damage.

### BACKGROUND OF THE INVENTION

Adhesive tapes, such as, for example, pressure-sensitive adhesive tapes, are usually firmly bonded to surfaces because subsequent separation of the adhesive strip from the substrates not desired. However, there are adhesive strips wherein the adhesives are formulated to allow clean and easy removal from surfaces after use. These adhesives usually do not exhibit a substantial level of holding power, e.g., greater than 4 to 6 oz./in. adhesion to standard copy paper and it becomes difficult to attach with rough surfaces. Adhesives formulated to provide a substantial level of adhesion greater than 30 oz./in. adhesion to paper, are generally difficult to remove without damaging the substrate. These adhesives usually do not exhibit the separation of major surfaces between the adhesive strips.

Many types of adhesive products have been developed which permit the separable connection of plural objects. For example, laminated tape structures have been used to bond the opposed surfaces of two objects together, such as to bond a wall hanging to the surface of a wall.

In order to separate connections, the adhesive product may comprise an easily releasable adhesive permitting removal from a surface while leaving little or no adhesive residue on the surface. Examples include repositionable products available under the trade designation “Post-it” from Minnesota Mining and Manufacturing Company (“3M”) of St. Paul, Minn.

Another type of removable adhesive tape is a single-sided or double sided adhesive tape that is stretchable to accomplish removal. Alternatively, the adhesive may comprise a solid adhesive material that itself provides one or two adhesive surfaces and is sufficiently extensible. These tapes are often referred to as stretch release adhesive tapes because when the backing or solid adhesive layer is stretched by pulling the tab strip after the tape is adhered on one or both sides, the adhesive stretches and undergoes clean interfacial debonding from the surface to which it is adhered. Examples of such strips and tabs are described in U.S. Pat. No. 5,409,189 to Luhmann and U.S. Pat. No. 5,516,581 to Kreckel et al, and in U.S. patent application Ser. Nos. 08/308,937 entitled “Removable Foam Adhesive Tape” filed Sep. 20, 1994 and 08/940,555 entitled “Removable Adhesive Tape with Controlled Sequential Release” filed Sep. 30, 1997, both to Braes et al. An article support specifically designed for use with such stretch release tapes is disclosed in U.S. Pat. No. 5,507,464 to Hamerski et al. An advantage of these stretch release adhesive tapes is that they utilize pressure sensitive adhesives that can provide a strong bond against shear, peel and lift-off forces. Moreover, heavier weighted objects can be supported.

With these stretch releasable tape strips, access must be provided to the tab to permit the release. In the case where the strip is provided between an object support, e.g. a picture hook, and a surface, e.g. a wall, the tab can be provided easily where the support and exposed tab will be covered by the object to be supported thereon. Also, with object supports, such as a picture hook, the hook can be reusable by providing a new tape strip. If, however, it is desirable to directly connect an object to a surface by a stretch releasable strip, the tab needs to extend out from between the opposed surfaces to provide access. In many cases, this can provide an objectionable appearance.

To overcome this problem, U.S. patent application Ser. No. 08/746,351 entitled “Internally Separable Tape Laminate” describe a tape laminate structure has been developed having an internally separable layer. A tape structure is provided that can be used to bond together the opposed surfaces of objects with no portion of the tape structure projecting from between the objects and which permits separation of the objects. The tape structure comprises separable layer provided between one or two stretch releasable tape strips. By this construction, the objects can be first separated from one another by applying a force substantially perpendicular to the surface direction of the tape lamina causing the internally separable layer to break within itself. That is, a portion of the layer stays attached to one object while another portion of the internal layer stays with the other object Then, with the objects separated, each layer portion can be removed from its respective object by pulling a stretch release tab and it allows to support significant weight at least 6 pounds per square inch.

U.S. Pat. No. 4,024,312 entitled “Pressure-sensitive adhesive tape having extensible and elastic backing composed of a block copolymer” assigned by Johnson and Johnson describes adhesive tape which comprises a highly extensible and elastic backing film laminated with an adhesive layer to form the tape. The tape is easily stretchable and normally may be removed easily from an application surface by stretching the tape lengthwise in a direction substantially parallel to the surface. This characteristic is highly important in medical applications where painless removal is desirable.

U.S. Pat. No. 6,231,962 entitled “Removable foam adhesive tape” and U.S. Pat. No. 6,403,206B1 adhesive tapes which comprise a layer of polymeric foam in the backing and may be adhered firmly to a surface and there after removed therefrom after only being stretched at an specific angle from surface of the substrate. Articles for mounting an object such as a picture to a surface such as a wall comprising a pressure-sensitive adhesive tape of the invention are also described.

Many reusable fastener systems are also known to be provided with adhesive on their respective non-connector side surfaces for bonding to the objects which are to be connected. For example, the hook side of a hook and loop system may be adhered to one object while the loop side is adhered to another object. Although these fastener systems permit the separation of one object from another, each of the objects retains its portion of the fastener system, which are not easily removable.

Despite various improvements and progress in the field, some of the major obstacles that still exist, such as ease of separation even from rough surface and holding the weight up to 50 lbs/sq inch. In addition, it would be a significant improvement in the stretching tab that provide non adhesive surface and provides easy release from the surfaces of the object and provide release between both adhesive strips.

Accordingly, improvements are needed in the existing methods and structures that negate the above shortcomings in the existing systems.

### SUMMARY OF THE INVENTION

The present invention provides an improvement to adhesive article with stretchable mesh strip for use for easy release of an adhesive strip from any shaped surfaces of objects even from the rough surfaces of the objects and provide release between both strips by pulling central mesh. The improvement lies within the ability to control the ease of the debonding of both surfaces so that one adhesive surface releases from the other and can hold the weight up to 50 lbs/sq inch, The non-adhesive hexagonal mesh network layer provides the ease for the separation of objects, the aforementioned problems can be minimized.

A stretch releasing adhesive article adapted to be easily removable, strongly affixed to any shaped surfaces, having two versions.

first version comprises:

(a) non-adhesive mesh layers, of hexagonal repeated network with pulling loops, attached with wax covered strips which can be easily peel off on both ends of the said adhesive article, and

(b) adhesive layers sandwiched between said mesh layers which is affixed to top and bottom major surfaces of said adhesive layers,
wherein a manually engageable said pulling loops attached with said hexagonal mesh network that effect progressive debonding of the said major surfaces of said adhesive layer from surfaces of the objects on both ends by stretching the said pulling loops of said mesh layer, after the adhesive surface is bonded to that said object, by the application of a force in between its said first and second ends.

Second version comprises:

(a) non-adhesive mesh layers, of hexagonal repeated network with pulling loops, attached with wax covered strips which can be easily peel off on both ends of the said adhesive article with a central mesh layer sandwiched between the major surface of first adhesive strip and second adhesive strip layers from both sides,

(b) adhesive layers sandwiched between said mesh layers, affixed to top and bottom major surfaces of said adhesive layers,
wherein a manually engageable said pulling loops attached with said mesh layers on both ends that effect progressive debonding of the said major surfaces of said adhesive layer from surfaces of the objects on said both ends by stretching the said pulling loops of said mesh layers, after the adhesive surfaces is bonded to that said surfaces of objects, by the application of a force in between its said first and second ends.
wherein a manually engageable said pulling loops attached with said central mesh layer that effect progressive debonding of the said major surfaces of said adhesive layers from each other said major surfaces by stretching the said pulling loops of said central mesh layer.

The adhesive article includes removable mesh strips with lobes on the outside of the strip that provide the ease of separation of the surfaces from the object from any of the end and provide ease of separation between the adhesive strips. It further includes double-sided adhesive strips that attach with any shaped surfaces of the object even on rough surfaces that can bold heavy weight up to 50 lbs/sq inch. In accordance with a characterizing feature of the invention, the mesh strip prevents relative movement between the adhesive strips and the surfaces of the objects and therefore increases successful sequential release. By preventing relative movement between the adhesive strip and the surface and the stretch release of the double-sided layer also protect the surface from damage.

In another embodiment, the mesh layer is arranged on both to and bottom ends of the adhesive article. The mesh layer is made up from synthetic thread material which forms repeated blocks of hexagonal configuration with pulling lobes made up from the stretchable synthetic thread connected outside the hexagonal shaped mesh strip. The hexagonal shape provides the proper surface to mesh strip for ease of release of the double-sided adhesive strips from the surfaces of the objects and release between the adhesive strips during the release process.

### DESCRIPTION OF THE DRAWINGS

The present invention will be further described with reference to the accompanying drawings, in which:

FIG. 1 is a cross-sectional view of first version adhesive article affixed with surfaces depicting an embodiment of the present invention.

FIG. 2 is a cross-sectional view of first version adhesive article depicting an embodiment of the present invention.

FIG. 3 is a cross-sectional view of second version adhesive article depicting an embodiment of the present invention.

FIG. 4a is a cross-sectional view of second version adhesive article affixed with surface depicting an embodiment of the present invention.

FIG. 4b is a cross-sectional side view of the second version adhesive article depicting the embodiments of the present invention.

FIG. 5 is a cross-sectional view of the mesh strip depicting an embodiment of the present invention.

FIG. 6a is a cross-sectional view of the cover strip depicting an embodiment of the present invention.

FIG. 6b is a cross-sectional view of the adhesive layer depicting an embodiment of the present invention.

FIG. 7a is a cross-sectional side view of the second version adhesive strip depicting an embodiment of the present invention.

FIG. 7b is a cross-sectional side view of the first adhesive strip depicting an embodiment of the present invention.

### LIST OF REFERENCE NUMBERING

10 labels a first mesh layer

11 labels side lobes of first strip

12 labels side lobes of second strip

13 labels front back lobes of first strip

14 labels front back lobes of second strip

15 labels an adhesive strip of first version

16 labels a first end of the object surface

17 labels a second end of the object surface

18 labels a first major surface of the adhesive strip

19 labels a second major surface of the adhesive strip

20 labels a second mesh layer

30 labels a central mesh of second version

31 labels a first adhesive strip of second version

41 labels a stretchable thread

42 labels a hexagonal block

44 labels a front back view of a mesh

45 labels a side view of a mesh

50 labels a wax covered strip

51 labels a lobe of wax covered strip

52 labels a front back view of covered strip

53 labels a side view of covered strip

55 labels a front back view of adhesive strip

63 labels side lobes of central mesh

64 labels front back lobes of central mesh

100 labels a first version of adhesive article

200 labels a second version of adhesive article

### DETAILED DESCRIPTION OF THE INVENTION

In order for the specific improvements of the present invention to be easily understood and appreciated, the construction and operation of the currently known stretch releasing adhesive article with hexagonal mesh, will be described in detail. The adhesive strip is double sided strip provides the adhesive properties on both side surfaces of the both ends. The adhesive article has two version, first version provides the ease of release from the surfaces of the objects from the adhesive strip and second version provide the additional property provides release between the adhesive strips with the help central mesh layer which is sandwiched between these adhesive strips.

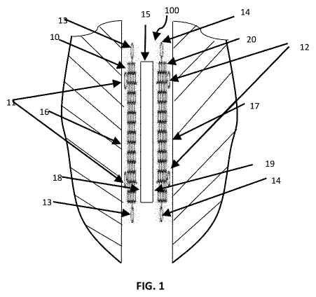

Referring first to FIG. 1 there is shown a first version of the typical first version 100 of adhesive article affixed to the surfaces of objects 16, 17 from both the ends of the mesh layers 10, 20 respectively of the adhesive article. The first version 100 of adhesive article is able to attach with any shaped surfaces even on rough surfaces of the object from either of the end. The adhesive article 100 includes an adhesive strip 15 which adhesively bonds the strip major surfaces 18, 19 to the any object surfaces 16, 17 respectively on both ends and stretch releasing adhesive mesh strips 10, 20 that provide easy release of the surfaces. The mesh layers 10, 20 made of stretchable synthetic thread 41 in hexagonal 42 repeated arrangement to facilitate the stretch removal process by pulling the side lobes 11, 12 and front back lobes 13, 14 attached outside the mesh layers. The adhesive article 100 includes adhesive strip having opposite top and bottom major surfaces 18, 19, affixed with first and second ends 16, 17 of the surfaces respectively, and includes a mesh layers 10, 20 which can be stretch and pulled by a user from pulling the side lobes 11, 12 and front back lobes 13, 14 attached outside the mesh strips 10, 20 to effect the stretch release of the adhesive article 100 either of the first and second ends 16, 17. The adhesive strip 15 top surface has a first major surface 18 and bottom surface has a second major surface 19 adjacent to the adhesive strip first end 16 and second end 17 respectively which defines a release area and permits sequential release of the surfaces 16, 17 from the adhesive strip surfaces 18, 19 respectively by pulling the side lobes 11, 12 and front back lobes 13, 14 attached outside the mesh layers. The release area can include a mesh strip 10, 20 which provides a non-adhesive zone, include a hexagonal shaped 42 mesh strips 10, 20 made up from synthetic stretchable thread 41 which provides suitable arrangement to release from end of the surfaces 16, 17. The adhesive layer top and bottom surfaces 18, 19 includes an adhesive property for adhesively bonding for the adhesive strip 15 to the any object surface 16, 17.

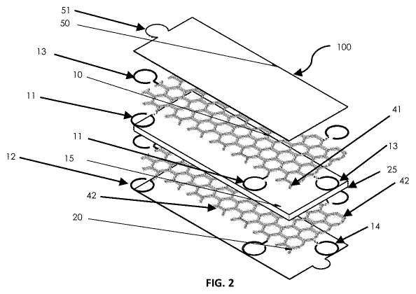

In FIG. 2 shows the first version 100 of adhesive article includes mesh layers covered outside with cover strips 50 which can be easily peel off before applying on the surface of the object. The first version 100 of the adhesive article includes an adhesive strip 15 which adhesively bonds the strip major surfaces 18, 19 to the any object surfaces 16, 17 respectively on both ends and stretch releasing adhesive mesh strips 10, 20 that provide easy release of the surfaces. The mesh layers 10, 20 made of stretchable synthetic thread 41 in hexagonal 42 repeated arrangement to facilitate the stretch removal process by pulling the side lobes 11, 12 and front back lobes 13, 14 attached outside the mesh layers. The first version 100 of the adhesive article includes adhesive strip having opposite top and bottom major surfaces 18, 19, affixed with first and second ends 16, 17 of the surfaces respectively, and includes a mesh layers 10, 20 which can be stretched and pulled by a user from pulling the side lobes 11, 12 and front back lobes 13, 14 attached outside the mesh strips 10, 20 to effect the stretch release of the first version 100 of adhesive article either of the first and second ends 16, 17. The adhesive strip 15 top surface has a first major surface 18 and bottom surface has a second major surface 19 adjacent to the adhesive strip first end 16 and second end 17 respectively which defines a release area which permits sequential release of the surfaces 16, 17 from the adhesive strip surfaces 18, 19 respectively by pulling the side lobes 11, 12 and front back lobes 13, 14 attached outside the mesh layers. The release area can include a mesh strips 10, 20 which provides a non-adhesive zone, include a hexagonal 42 shaped mesh strips 10, 20 made up from synthetic stretchable thread 41 which provides suitable arrangement to release from end of the surfaces 16, 17. The adhesive layer top and bottom surfaces 18, 19 includes an adhesive property for adhesively bonding for the adhesive strip 15 to the any object surfaces 16, 17.

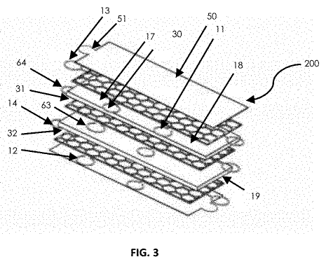

Referring now to FIG. 3, there is shown a second version 200 of the typical adhesive article is able to attach with any shaped surfaces even on rough surfaces of the objects. The second version 200 of adhesive article includes two adhesive strips 31, 32 which sandwiched adhesive central mesh 30 between them with side lobes 63 and front back lobes 64. The mesh layers 10, 20, 30 made of stretchable synthetic thread 41 in hexagonal repeated block 42 arrangement to facilitate the stretch removal process by pulling the side lobes 11, 12, 63 and front back lobes 13, 14, 64 attached outside the mesh layers. The top surface of adhesive strip 31 is a first major surface and bottom surface of adhesive strip 32 is a second major surface which defines a sequential release of the adhesive strip surfaces 18, 19 by pulling the side lobes 11, 12 and front back lobes 13, 14 respectively, attached outside the mesh layers. The central mesh 30 provides the release between the strips 31, 32 by pulling the side lobes 63 and front back lobes 64. The release area can include a mesh strip 10, 20, 30 which provides a non-adhesive zone, includes a hexagonal shaped 42 mesh strips 10, 20, 30 made up from synthetic stretchable thread 41 which provides suitable arrangement to release of the adhesive strips 31, 32. The adhesive layers top and bottom surfaces 18, 19 includes an adhesive property for adhesively bonding for the adhesive strip 31, 32.

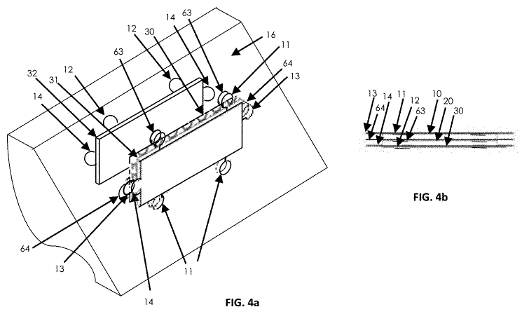

FIG. 4a shows the second version 200 of adhesive article includes mesh layers 10, 20, 30 covered outside with cover strips 50 which can be easily peel off before applying on the surface 16, 17 of the object. The second version 200 adhesive article includes an adhesive strips 31, 32 which adhesively bonds the strip major surfaces 18, 19 to the any object surfaces 16, 17 respectively on both ends and stretch releasing adhesive mesh strips 10, 20 that provide easy release of the surfaces 16, 17 of the objects respectively and central mesh 30 provides easy release between the strips 31, 32 by pulling the loops 63, 64 of the mesh layer 30. The mesh layers 10, 20, 30 made of stretchable synthetic thread 41 in hexagonal 42 repeated arrangement to facilitate the stretch removal process by pulling the side lobes 11, 12, 63 and front back lobes 13, 14, 64 attached outside the mesh layers. The adhesive article 200 includes adhesive strips 31, 32 having opposite top and bottom major surfaces 18, 19, affixed with first and second ends 16, 17 of the surfaces respectively, and includes a mesh layers 10, 20, 30 which can be stretch and pulled by a user from pulling the side lobes 11, 12. 63 and front back lobes 13, 14, 64 attached outside the mesh strips 10, 20, 30 respectively to effect the stretch release of the adhesive article 200 either of the first second ends 16, 17 and provides release between adhesive strips 31, 32. FIG. 4b provides side view of the adhesive article 200 of the mesh layers 10, 20, 30 with side lobes 11, 12, 63 and front back lobes 13, 14, 64 The adhesive strips 31 top surface has a first major surface 18 and adhesive strip 32 bottom surface has a second major surface 19 adjacent to the adhesive strips first end 16 and second end 17 respectively which permits sequential release of the surfaces 16, 17 from the adhesive strip surfaces 18, 19 by pulling the side lobes 11, 12 and front back lobes 13, 14 attached outside the mesh layers. The central mesh 30 provides release between the adhesive strips 31, 32.

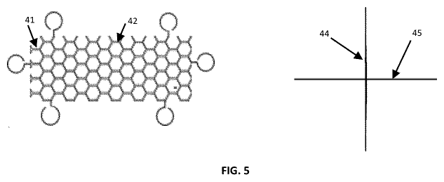

FIG. 5 shows the release area that include a mesh strip 10, 20, 30 which provides a non-adhesive zone, include a repeated network of hexagonal shaped 42 mesh strips 10, 20, 30 made up from synthetic stretchable thread 41 which provides suitable arrangement to release from end of the surfaces 16, 17. This includes front back view 44 and side view 45 of the mesh network.

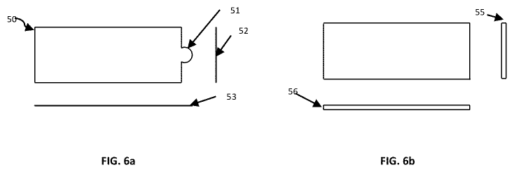

In FIG. 6a, there is shown a shape of cover strip 50 which can be easily peel off by stretching the lobe 51. The mesh layers 10, 20 attached on the other side of the cover which can be stretch and pulled by a user from pulling the side lobes 11, 12, 63 and front back lobes 13, 14, 64 attached outside the mesh strips 10, 20, 30 respectively to effect the stretch release of the first and second versions 100 and 200 respectively either of the first and second ends 16, 17 and provides the release between the adhesive strips 31, 32. FIG. 6b, shows shape of adhesive strip with front back view 55 and the side view 56 of the adhesive strips.

In FIG. 1b shows the first version 100 of adhesive article includes mesh layers covered outside with cover strips which can be easily peel off before applying on the surface of the object. The first version 100 of adhesive article includes an adhesive strip 15 which adhesively bonds the strip major surfaces 18, 19 to the any object surfaces 16, 17 respectively on both ends and stretch releasing adhesive mesh strips 10, 20 that provide easy release of the surfaces. The mesh layers 10, 20 made of stretchable synthetic thread 41 in hexagonal 42 repeated arrangement to facilitate the stretch removal process by pulling the side lobes 11, 12 and front back lobes 13, 14 attached outside the mesh layer. The first version 100 of adhesive article includes adhesive strip having opposite top and bottom major surfaces 18, 19, affixed with first and second ends 16, 17 of the surfaces, respectively, and includes a mesh layers 10, 20 which can be stretch and pulled by a user from pulling the side lobes 11, 12 and front back lobes 13, 14 attached outside the mesh strips 10, 20 to effect the stretch release of the adhesive article 100 either of the first and second ends 16, 17. The adhesive strip 15 top surface has a first major surface 18 and bottom surface has a second major surface 19 adjacent to the adhesive strip first end 16 and second end 17 respectively which defines a release area which permits sequential release of the surfaces 16, 17 from the adhesive strip surfaces 18, 19 respectively by pulling the side lobes 11, 12 and front back lobes 13, 14 attached outside the mesh layer. The release area can include a mesh strip 10, 20 which provides a non-adhesive zone, include a hexagonal 42 shaped mesh strips 10, 20 made up from synthetic stretchable thread 41 which provides suitable arrangement to release from end of the surfaces 16, 17.

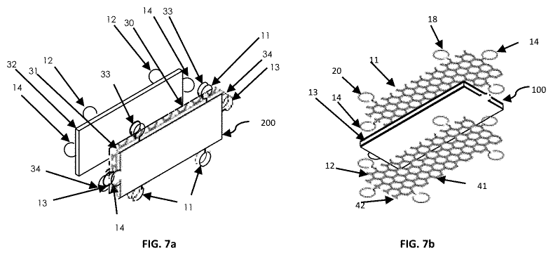

Referring now to FIG. 7a shows the second version 200 of adhesive article includes mesh layers 10, 20, 30 covered outside with cover strips 50 which can be easily peel off before applying on the surface of the object. The adhesive article 200 includes an adhesive strip 31, 32 which adhesively bonds the strip major surfaces 18, 19 to the any object surfaces 16, 17 respectively on both ends and stretch releasing adhesive mesh strips 10, 20 that provide easy release of the surfaces from surfaces 16, 17 of the objects and central mesh 30 provides easy release between the strips 31, 32. The mesh layers 10, 20, 30 made of stretchable synthetic thread 41 in hexagonal 42 repeated arrangement to facilitate the stretch removal process by pulling the side lobes 11, 12, 63 and front back lobes 13, 14, 64 attached outside the mesh layers. The adhesive article 200 includes adhesive strips 31, 32 having opposite top and bottom major surfaces 18, 19, affixed with first and second ends 16, 17 of the surfaces, respectively, and includes a mesh layers 10, 20, 30 which can be stretched and pulled by a user from pulling the side lobes 11, 12, 63 and front back lobes 13, 14, 64 attached outside the mesh strips 10, 20, 30 respectively to effect the stretch release of the adhesive article 200 either of the first second ends 16, 17 and provides release between each other affixed surfaces of the strips 31, 32. This article 200 is with addition feature of separation of adhesive layers 31, 32 by pulling the side lobes 63 and front back lobes 64 of the mesh layer 30.

Factors which contribute to the likelihood of the adhesive strip 15, 31, 32 releasing from the support surface 16, 17 and from each other Includes the following: (1) the release end surfaces 16, 17 which is too small, (2) the elongation force required to stretch the adhesive mesh strips 10, 20, 30 is high, (3) a weak adhesive bond exists between the adhesive, inadequate pressure being applied during installation, or not allowing enough time for an effective bond to form between the adhesive strip and the support surface. Because of the variety of factors which can interfere with the predictable and effective sequential release of the first and second version 100, 200 of adhesive articles from the support surfaces 16, 17 on both sides and between each other. This desirable to provide means whereby sequential release is more likely to be successful.

The first and second versions 100, 200 respectively includes adhesive strips 15 and 31, 32 respectively. This include the mesh layers 10, 20, 30 with sides lobes 11, 12 and front back lobes 13, 14 for easy release of the surfaces 16, 17 of any shaped object and strip is able to hold the weight up to the 50 lbs/sq inch. It has high capacity of handling the weight which make it more applicable for its use in different purposes such as for holding the heavy weight and for gripping two objects strongly with each other. In second version article 200, the mesh 30 provides the release between the strips 31, 32 by pulling the sides lobes 63, 64 of the mesh layer 30 which differentiate this adhesive article from first version adhesive article 100.

A stretch releasing adhesive article adapted to be easily removable, strongly affixed to any shaped surfaces, having two versions, first version comprises:

(a) non-adhesive mesh layers, of hexagonal repeated network with pulling loops, attached with wax covered strips which can be easily peel off on both ends of the said adhesive article, and

(b) adhesive layers sandwiched between said mesh layers which is affixed to top and bottom major surfaces of said adhesive layers,
wherein a manually engageable said pulling loops attached with said hexagonal mesh network that effect progressive debonding of the said major surfaces of said adhesive layer from surfaces of the objects on both ends by stretching the said pulling loops of said mesh layer, after the adhesive surface is bonded to that said object, by the application of a force in between its said first and second ends.

Second version comprises:

(a) non-adhesive mesh layers, of hexagonal repeated network with pulling loops, attached with wax covered strips which can be easily peel off on both ends of the said adhesive article with a central mesh layer sandwiched between the major surface of first adhesive strip and second adhesive strip layers from both sides,

(b) adhesive layers sandwiched between said mesh layers, affixed to top and bottom major surfaces of said adhesive layers,
wherein a manually engageable said pulling loops attached with said mesh layers on both ends that effect progressive debonding of the said major surfaces of said adhesive layer from surfaces of the objects on said both ends by stretching the said pulling loops of said mesh layers, after the adhesive surfaces is bonded to that said surfaces of objects, by the application of a force in between its said first and second ends.
wherein a manually engageable said pulling loops attached with said central mesh layer that effect progressive debonding of the said major surfaces of said adhesive layers from each other said major surfaces by stretching the said pulling loops of said central mesh layer.

It will be apparent to those of ordinary skill in the art that various changes and modifications may be made without deviating from the inventive concept. Thus, the scope of the present invention should not be limited to the structures described in this application, but only by the structures described by the language of the claims and the equivalents of those structures.

What is claimed is:

1. A stretch releasing adhesive article adapted to be easily removable, strongly affixed to any shaped surfaces, having two versions first version comprises:
(a) non-adhesive mesh layers, of hexagonal repeated network with pulling loops, attached with wax covered strips which can be easily peel off on both ends of the said adhesive article, and
(b) adhesive layers sandwiched between said mesh layers which is affixed to top and bottom major surfaces of said adhesive layers,
wherein a manually engageable said pulling loops attached with said hexagonal mesh network that effect progressive debonding of the said major surfaces of said adhesive layer from surfaces of the objects on both ends by stretching the said pulling loops of said mesh layer, after the adhesive surface is bonded to that said object, by the application of a force in between its said first and second ends.
Second version comprises:
(a) non-adhesive mesh layers, of hexagonal repeated network with pulling loops, attached with wax covered strips which can be easily peel off on both ends of the said adhesive article with a central mesh layer sandwiched between the major surface of first adhesive strip and second adhesive strip layers from both sides,
(b) adhesive layers sandwiched between said mesh layers, affixed to top and bottom major surfaces of said adhesive layers,
wherein a manually engageable said pulling loops attached with said mesh layers on both ends that effect progressive debonding of the said major surfaces of said adhesive layer from surfaces of the objects on said both ends by stretching the said pulling loops of said mesh layers, after the adhesive surfaces is bonded to that said surfaces of objects, by the application of a force in between its said first and second ends.
wherein a manually engageable said pulling loops attached with said central mesh layer that effect progressive debonding of the said major surfaces of said adhesive layers from each other said major surfaces by stretching the said pulling loops of said central mesh layer.

2. An adhesive article as defined in claim 1, wherein said mesh layers attached with said top and bottom major surfaces of the said adhesive strips on first and second ends and a said central mesh sandwiched between the said adhesive layers.

3. An adhesive article as defined in claim 2, wherein said mesh layer is made up from stretchable thread.

4. An adhesive article as defined in claim 3, wherein said mesh layer arranged as the said repeated blocks of hexagonal shaped.

4. An adhesive article as defined in claim 4, wherein said pulling lobes attached with said mesh layer to provide the easy stretch release of the layers.

5. An adhesive article as defined in claim 4, wherein said mesh layers attached with said major surfaces of adhesive layers further attached with the said surface of the object.

7. An adhesive article as defined in claim 5, wherein said adhesive article is applicable on any type of said surface of any shaped even on said rough surfaces.

9. An adhesive article as defined in claim 2, wherein said mesh layer has non-adhesive release provide easy release from the said surface of object, and between said adhesive strips.
